(19) United States
(12) Patent Application Publication
(10) Pub. No.: US 2021/0073799 A1
(43) Pub. Date: Mar. 11, 2021

(54) CRYPTO ASSET WALLET WITH ENHANCED SECURITY FEATURES FOR IDENTIFYING USERS AND REDUCING ANONYMITY, SYSTEM, AND METHOD

(71) Applicant: Thomas MESSINA, Scarsdale, NY (US)

(72) Inventor: Thomas MESSINA, Scarsdale, NY (US)

(21) Appl. No.: 16/803,754

(22) Filed: Feb. 27, 2020

Related U.S. Application Data
(60) Provisional application No. 62/897,324, filed on Sep. 7, 2019.

(51) Int. Cl. G06Q 20/36; G06F 21/32; G06F 21/55; G06Q 20/40; G06Q 20/38; G06K 9/00

(52) U.S. Cl. CPC G06Q 20/3678; G06F 21/32; G06F 21/554; G06Q 2220/00; G06Q 20/3829; G06K 9/00288; G06F 2221/034; G06Q 20/40145

(57) ABSTRACT

A system, method, and crypto asset wallet with enhanced security features aids to reduce the anonymity and potential illegal or other undesirable behavior during the use of the wallet. The system requires the user to enter information about themselves, verifies this information, screens the user against disallowed lists, and risk rates the user before the wallet is allowed to be activated. During a crypto asset transaction, the system verifies that both wallets in the transaction have similar security and user verification standards. The wallet can be linked to a financial institution. The wallet, through the system, has ongoing verification, security, and screening standards during the use and life of the wallet.

### CROSS REFERENCE TO RELATED APPLICATION AND INCORPORATION BY REFERENCE

This application claims priority to and is a non-provisional of the previously filed U.S. Provisional Patent Application titled CRYPTO ASSET WALLET WITH ENHANCED SECURITY FEATURES FOR IDENTIFYING USERS AND REDUCING ANONYMITY AND METHOD with an application filing date of Sep. 7, 2019 in the United States Patent and Trademark Office, with Application No. 62/897,324 by the same inventive entity. The entirety of Application No. 62/897,324 being incorporated herein by reference to provide continuity of disclosure.

### FIELD OF THE INVENTION

This invention relates to a crypto asset wallet with enhanced security features for identifying users and reducing anonymity, system, and method and more particularly to a crypto asset wallet with enhanced security features for identifying users and reducing anonymity and a method that requires user identification information and verification of this information during all stages of use of the wallet and requires that all wallets that transact with the initial wallet have the similar security and verification procedures. This invention also relates to a method for using the crypto asset wallet and a system to perform these functions.

### BACKGROUND OF THE INVENTION

Crypto assets are becoming increasingly popular as a medium of exchange in financial transactions. Crypto assets include cryptocurrency and examples of crypto assets include Bitcoin, Lite Coin, Ripple, Ethereum, Monero, and Zcash and there are many other forms of crypto assets and all such forms are referred to in this disclosure as “crypto assets”. Crypto assets have many advantages over other forms of currency, but there are disadvantages as well. One of the main disadvantages of crypto assets is the risk of anonymity in a financial transaction. When a user sends, receives, or otherwise manages crypto assets with a second party, there is no way to identify who the user or the second party is. This leaves crypto asset transactions highly vulnerable to use for criminal and other undesirable activity. A crypto asset wallet, system, and method of reducing anonymity in the use of crypto assets will be a useful invention.

The sending and receiving of crypto assets is managed by a crypto asset wallet. A crypto asset wallet is a computer program or software that allows the user to send, receive, and otherwise manage crypto assets. The current crypto asset wallets on the market do not require any identification of the user to activate or use the wallet. Without a way of identifying who a user is, there is no way to know if the user may be involved in nefarious activity or may be sending or receiving crypto assets in a sanctioned or otherwise disallowed location. A crypto asset wallet, system, and method that provides for user identification and location will be a useful invention.

Moreover, when a user wants to send, receive, or otherwise manage crypto assets, the user may be identified. However, the second party in the transaction may be anonymous. The first user in the transaction may be an identified and reputable user. However, the second user may be anonymous and involved in nefarious activity or sending or receiving crypto assets in a sanctioned or otherwise disallowed location. A crypto asset wallet, system, and method that requires identification of both the sender and receiver in a transaction will be a useful invention.

Financial institutions have to abide by regulatory and tax compliance standards. The user may access a bank account at a financial institution to transfer money or assets related to crypto assets. If the financial institution cannot verify who the user is, the financial institution cannot meet its regulatory and compliance standards. Financial institutions in traditional, non-crypto asset transactions and relationships have to abide by established standards to validate the identity of its customers. Financial institutions must abide by established standards of customer due diligence, on-boarding, maintenance, and transaction disclosure requirements. These standards are not present in the current crypto asset space. A crypto asset wallet, system, and method that meets current standards imposed on financial institutions for identifying their clients in the traditional setting, with or without a banking relationship, will be a useful invention.

### SUMMARY OF THE INVENTION

Among the many objectives of the present invention is the provision of a crypto asset wallet with enhanced security features for identifying users and reducing anonymity, system, and method which requires the user to input identifying information and to provide documentation of their identity.

Another objective of the present invention is the provision of a crypto asset wallet with enhanced security features for identifying users and reducing anonymity, system, and method which screens users against disallowed lists to minimize use of the wallet by criminals, terrorists, sanctioned entities, or other people or entities who do not meet established standards or criteria.

Moreover, an objective of the present invention is the provision of a crypto asset wallet with enhanced security features for identifying users and reducing anonymity, system, and method that verifies user identity and suitability for use of the wallet at the initial setup of the wallet and during use of the wallet.

A further objective of the present invention is the provision of a crypto asset wallet with enhanced security features for identifying users and reducing anonymity, system, and method which identifies both the sender and receiver in a transaction to verify that both of their identities have been verified by the standards of the wallet, system, and method of this invention.

A still further objective of the present invention is the provision of a crypto asset wallet with enhanced security features for identifying users and reducing anonymity, system, and method which can deactivate the wallet if a security or other threat is detected or if a sender or receiver's identity cannot be verified, or if there is an adverse change in the user's information.

Other objectives and advantages of the present invention will become apparent to those of ordinary skill in the art upon review of the disclosure herein.

### BRIEF DESCRIPTION OF THE DRAWINGS

FIG. 1 depicts a relational schematic demonstrating the relationship between the various components of system 200.

FIG. 2 depicts an abstract schematic of a physical embodiment of the 105 series of electronic devices 14, 250, 290, 300, 350, 400, and 500.

FIG. 3 is a process flow diagram of the wallet on-boarding process 20 of this invention.

FIG. 4 is a process flow diagram of the wallet maintenance and security process 28 of this invention.

FIG. 5 is a process flow diagram of the wallet opening screening process 34 of this invention.

FIG. 6 is a process flow diagram of the wallet transaction process 24 of this invention.

FIG. 7 is a process flow diagram of the optional financial institution linking process 26 of this invention.

FIG. 8a depicts a screen shot of the wallet on-boarding process 20 of this invention.

FIG. 8b depicts a screen shot of the wallet on-boarding process 20 of this invention.

FIG. 8c depicts a screen shot of the wallet on-boarding process 20 of this invention.

FIG. 9a depicts a screen shot of the wallet transaction process 24 of this invention.

FIG. 9b depicts a screen shot of the wallet transaction process 24 of this invention.

FIG. 9c depicts a screen shot of the wallet transaction process 24 of this invention.

FIG. 10a depicts a screen shot of the optional financial institution linking process 26 of this invention.

FIG. 10b depicts a screen shot of the optional financial institution linking process 26 of this invention.

Throughout the figures of the drawings, where the same part appears in more than one figure of the drawings, the same number is applied thereto.

### DESCRIPTION OF THE PREFERRED EMBODIMENTS

Reference will now be made in detail to several embodiments of the invention that are illustrated in accompanying drawings. Whenever possible, the same or similar reference numerals are used in the drawings and the description to refer to the same or like parts or steps. The drawings are in simplified form and are not to precise scale. For purposes of convenience and clarity only, directional terms such as top, bottom, left, right, up, down, over, above, below, beneath, rear, and front, can be used with respect to the drawings. These and similar directional terms are not to be construed to limit the scope of the invention in any manner. The words attach, connect, couple, and similar terms with their inflectional morphemes do not necessarily denote direct or intermediate connections, but can also include connections through mediate elements or devices.

The wallet of this invention is accessed via one or more computer programs, software, or software applications. If a software application is used, the software application may be a dynamic web-based application which can be used on any electronic device (including, but not limited to, a smart phone, tablet, laptop computer, desktop computer, etc.) (hereinafter “electronic device”) which can access the global computer network, or any other appropriate type of software application. The wallet can either be a software wallet which is a computer program, software, or software application that a user can install or download onto their electronic device via the global computer network and once installed or downloaded, the user can create an individual, personal account, or if the user is an entity, a commercial account.

Or, the wallet can be a hardware wallet in which the computer program, software, or software application to run the wallet is installed on computer hardware and the computer program, software, or software application can interact with the global computer network or crypto assets exchanges or other wallets when the hardware is installed on or otherwise communicating or interacting with an electronic device. Or, the wallet can be encompassed in any appropriate form of computer program and all such forms are encompassed by this disclosure.

The wallet of this invention is used for many functions. The wallet of this invention can store, send, and receive crypto assets. Crypto assets is a general term that refers to a digital representation of value that can be digitally traded, or transferred, and can be used for payment or investment purposes over a distributed ledger (e.g. block chain) using cryptography which makes the parties of a transaction pseudo-anonymous to one another and others who view the distributed ledger. Crypto assets include all forms of crypto currencies among other crypto assets.

Also, the wallet of this invention is a link to the real-world identities of parties to a transaction and this link and knowing who these parties are is important when financial institutions or other individuals or entities need to comply with established regulations to aid in preventing financial crimes or other nefarious activity.

Throughout this disclosure, the term “disallowed list” will be utilized. The term disallowed list is meant to include any state, national, country, governmental, and all other lists of individuals, institutions, corporations or other legal entities, civic or government organizations, or any other group or entity that may be of concern and whose financial transactions may need to be monitored, limited, or terminated. These lists can include people, entities, or any other groups suspected of or convicted of criminal, terrorist, or other potentially harmful, discouraged, or nefarious behavior. The disallowed list can include the Office of Foreign Asset Control (OFAC) watch list and the Specially Designated Nationals and Blocked Persons (SDN) watch list. The disallowed list does not have to be sanctioned by any entity and may include any list of interest and includes lists created solely for use by the system of this invention. Or, this list may include countries or other geographical locations that do not have laws as strict as a desired. One or more lists can be used and throughout this disclosure the term “disallowed list” will be used and is understood to be one or more lists and any list can be used and is encompassed by this disclosure.

The system of this invention brings many of the security, regulatory, and compliance standards that traditional financial institutions use to identify and verify the identity of its clients to the crypto assets space. For example, financial institutions regularly use a process called “Know Your Client” or “KYC” to screen potential new clients of the financial institution for suitability as clients of the financial institution and to reduce the risk that the new client is a criminal, terrorist, or other government sanctioned individual, group or entity and to reduce the risk that the new client will use the banking relationship to fund illegal, terrorist, or other nefarious activities. Financial institutions must also comply with Anti-Money Laundering and Combat Terrorist Finance regulations (AML/CTF) as established by law. There are also many tax compliance controls that traditional financial institutions must abide by. This is not meant to be an exhaustive list of all laws and regulations that require financial institution compliance and all laws and regulations that require financial institution compliance are encompassed by this disclosure. Some or all of these traditional financial institution laws, regulations, compliance standards, or variations thereof, may be incorporated into the system of this invention.

Throughout this disclosure the term “disallowed area” will be utilized. This term is meant to include any area including a city, a state, a province, a country, a continent, or any other suitable designation of a physical space. The disallowed area can be areas for which a government has established sanctions against and instituted trade embargos. Or, a disallowed area can be an area of high criminal or terrorist activity. Or, a disallowed area can include any area that the system of this invention specifies and these examples are meant to be exemplary of the possible disallowed areas and any demarcation of a disallowed area can be utilized and is encompassed by this disclosure.

The system of this invention can have features such as wallet lockouts, clearance accounts, chargebacks, and reversals. This is meant to be an exemplary list and any feature utilized in a traditional financial institution setting can be added to the system of this invention and is encompassed by this disclosure.

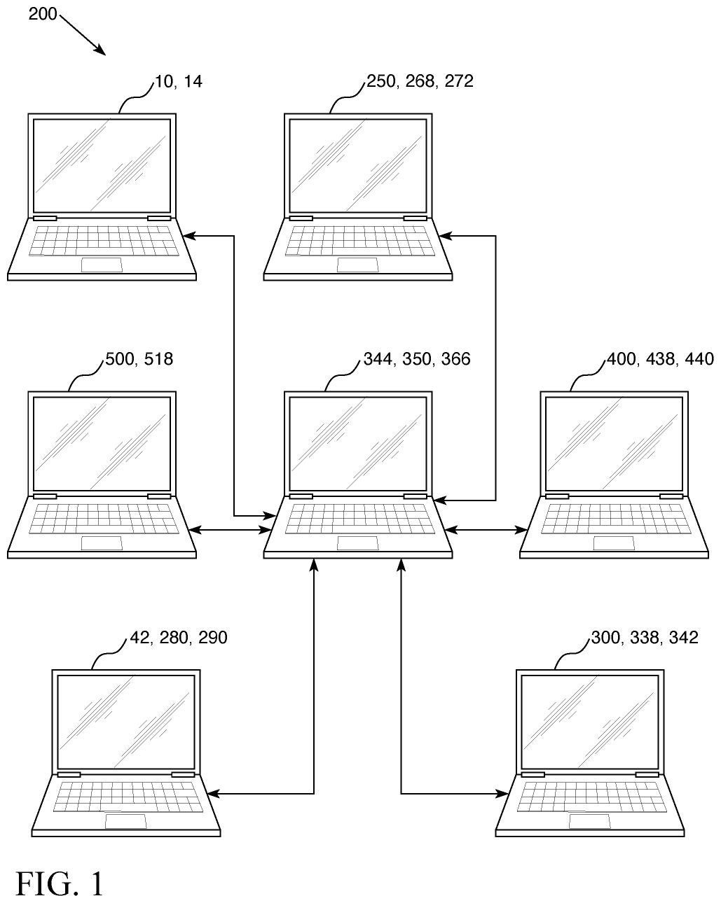

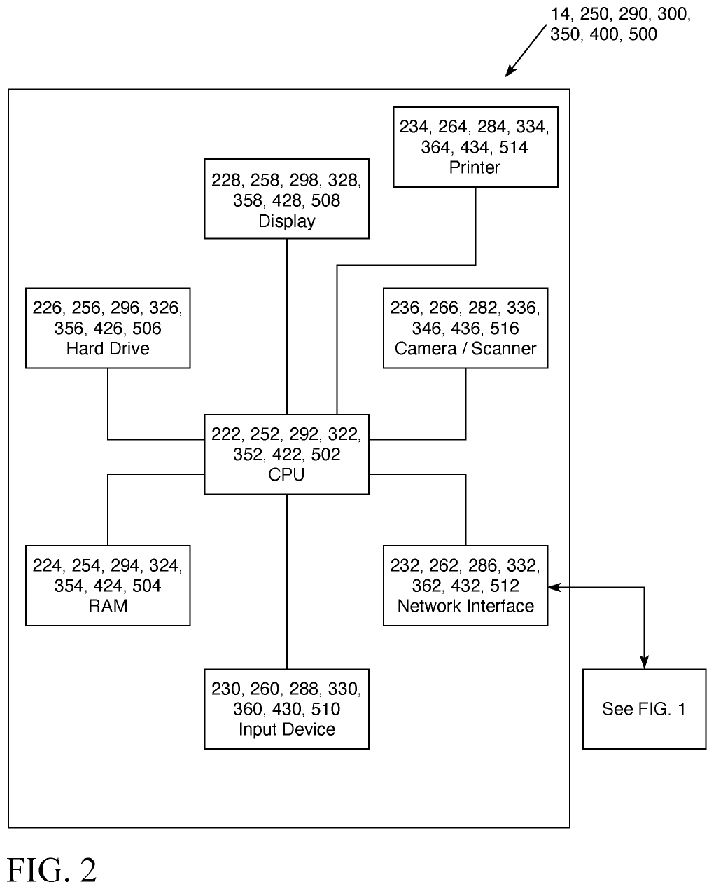

Now referring to FIGS. 1 and 2, system 200 of this invention can be clearly seen. System 200 may have any or all of the following: sender's wallet electronic device 14, screening service electronic device 250, wallet validation service electronic device 290, financial institution electronic device 300, wallet service provider electronic device 350, verification service electronic device 400, and receiver's wallet electronic device 500. Any of electronic devices 14, 250, 290, 300, 350, 400, or 500 can be one or multiple electronic devices.

Sender's wallet electronic device 14 may have any or all of the following: sender's wallet electronic device CPU 222, sender's wallet electronic device RAM 224, sender's wallet electronic device hard drive/persistent storage device 226, sender's wallet electronic device display 228, sender's wallet electronic device input device 230 (which can include a keyboard, mouse, or touch screen, but any suitable input device can be used and is encompassed by this disclosure), sender's wallet electronic device network interface 232, sender's wallet electronic device printer 234, and sender's wallet camera or scanner 236.

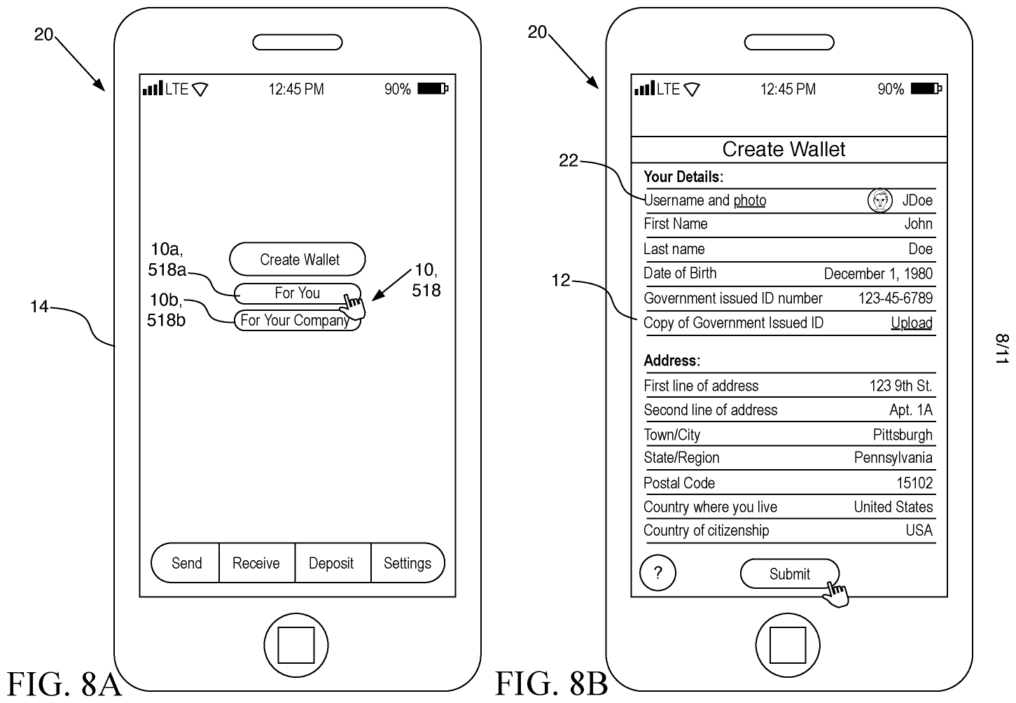

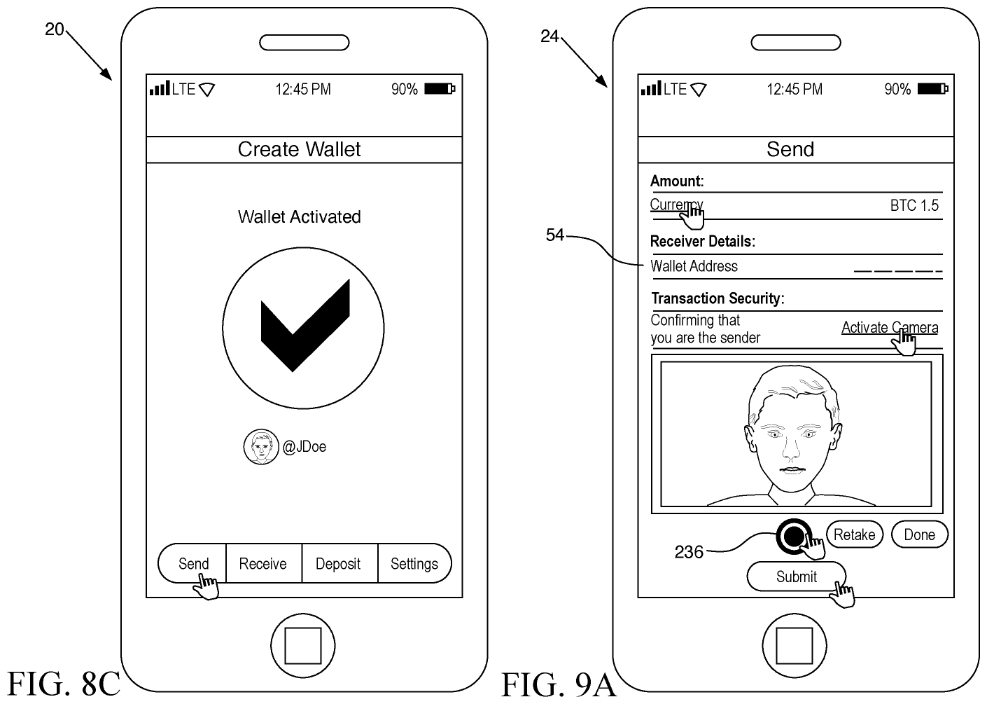

Sender's wallet electronic device CPU 222 causes the instructions of wallet 10, which are stored on hard drive/persistent storage device 226, to be read into sender's wallet electronic device RAM 224 and then executes them and the relevant wallet information 32 is displayed on sender's wallet electronic device display 228 (relevant wallet information 32 can be the screen shots depicted in FIG. 8a through FIG. 10b or any other relevant data). The user interacts with the senders' wallet electronic device 14 through sender's wallet electronic device input device 230.

Through wallet 10 and wallet service provider software 366, sender's wallet electronic device 14 is able to communicate with wallet service provider electronic device 350. Through wallet 10 and sender's wallet electronic device network interface 232 and wallet service provider electronic device network interface 362, information can be sent and received between sender's wallet electronic device 14 and wallet service provider electronic device 350.

Wallet service provider electronic device 350 may have any or all of the following: wallet service provider electronic device CPU 352, wallet service provider electronic device RAM 354, wallet service provider electronic device hard drive/persistent storage device 356, wallet service provider electronic device display 358, wallet service provider electronic device input device 360 (which can include a keyboard, mouse, or touch screen, but any suitable input device can be used and is encompassed by this disclosure), wallet service provider electronic device network interface 362, wallet service provider electronic device printer 364, and wallet service provider electronic device camera or scanner 346.

Wallet service provider electronic device 350 may have either one or more databases 344 stored on its wallet service provider electronic device hard drive/persistent storage device 356 or has access to one or more remote databases 344. The communication between wallet service provider electronic device 350 and sender's wallet electronic device 14 allows the sending and receiving of information between the two, including information contained in databases 344. Wallet service provider software 366 operating on wallet service provider electronic device CPU 352 accesses databases 344 to receive information from and send information to sender' wallet electronic device 14.

Wallet service provider electronic device CPU 352 causes the instructions of wallet service provider software 366, which are stored on hard drive/persistent storage device 356, to be read into wallet service provider electronic device RAM 354 and then executes them. Through wallet 10, software 366, and network interfaces 232 and 362, information can be sent and received between sender's wallet electronic device 14 and wallet service provider electronic device 350.

The user, through sender's wallet electronic device 14, may cause wallet service provider electronic device 350, either directly or through input which is processed by the instructions stored on wallet service provider electronic device hard drive/persistent storage device 356, to send or obtain information or other relevant data to or from remote electronic devices 250, 290, 300, 400, and 500 through sender's wallet electronic device network interfaces 232 and wallet service provider electronic device network interface 362.

Screening service 50 may have screening service electronic device 250. Screening service electronic device 250 may have any or all of the following: screening service electronic device CPU 252, screening service electronic device RAM 254, screening service electronic device hard drive/persistent storage device 256, screening service electronic device display 258, screening service electronic device input device 260 (which can include a keyboard, mouse, or touch screen, but any suitable input device can be used and is encompassed by this disclosure), screening service electronic device network interface 262, screening service electronic device printer 264, and screening service electronic device camera or scanner 266.

Screening service electronic device 250 may have either one or more databases 268 stored on its screening service electronic device hard drive/persistent storage device 256 or has access to one or more remote databases 268. Screening service electronic device CPU 252 causes the instructions of screening service software 272, which are stored on hard drive/persistent storage device 256, to be read into screening service electronic device RAM 254 and then executes them to allow screening service electronic device 250 to receive information from and send information to wallet service provider electronic device 350 through network interfaces 262 and 362.

Wallet service provider electronic device CPU 352, through wallet service provider software 366, allows wallet service provider electronic device 350 to communicate with screening service electronic device 250. The communication between wallet service provider electronic device 350 and screening service electronic device 250 allows the sending and receiving of information between the two, including information contained in databases 268 and 344. Screening service software 272 operating on screening service electronic device CPU 252 accesses databases 268 to receive information from and send information to wallet service provider electronic device 350.

Wallet validation service 40 may have wallet validation service electronic device 290. Wallet validation service electronic device 290 may have any or all of the following: wallet validation service electronic device CPU 292, wallet validation service electronic device RAM 294, wallet validation service electronic device hard drive/persistent storage device 296, wallet validation service electronic device display 298, wallet validation service electronic device input device 288 (which can include a keyboard, mouse, or touch screen, but any suitable input device can be used and is encompassed by this disclosure), wallet validation service electronic device network interface 286, wallet validation service electronic device printer 284, and wallet validation service electronic device scanner or camera 282.

Wallet validation service electronic device 290 may have either one or more databases 42 stored on its wallet validation service electronic device hard drive/persistent storage device 296 or has access to one or more remote databases 42.

Wallet validation service electronic device CPU 292 causes the instructions of wallet validation service software 280, which are stored on hard drive/persistent storage device 296, to be read into wallet validation service electronic device RAM 294 and then executes them to allow wallet validation service electronic device 290 to receive information from and send information to wallet service provider electronic device 350 through network interfaces 286 and 362.

Wallet service provider electronic device CPU 352, through wallet service provider software 366, allows wallet service provider electronic device 350 to communicate with wallet validation service electronic device 290. The communication between wallet service provider electronic device 350 and wallet validation service electronic device 290 allows the sending and receiving of information between the two including information contained in databases 42 and 344. Wallet validation service software 280 operating on wallet validation service electronic device CPU 292 accesses databases 42 to receive information from and send information to wallet service provider electronic device 350.

Through receiver's wallet 518, receiver's wallet electronic device 500 is able to communicate with wallet service provider electronic device 350. Receiver's wallet electronic device 500 may have any or all of the following: receiver's wallet electronic device CPU 502, receiver's wallet electronic device RAM 504, receiver's wallet electronic device hard drive/persistent storage device 506, receiver's wallet electronic device display 508, receiver's wallet electronic device input device 510 (which can include a keyboard, mouse, or touch screen, but any suitable input device can be used and is encompassed by this disclosure), receiver's wallet electronic device network interface 512, receiver's wallet electronic device printer 514, and receiver's wallet electronic device camera or scanner 516.

Receiver's wallet electronic device CPU 502 causes the instructions of receiver's wallet 518, which are stored on hard drive/persistent storage device 506, to be read into receiver's wallet electronic device RAM 504 and then executes them to allow receiver's wallet electronic device 500 to receive information from and send information to wallet service provider electronic device 350 through network interfaces 362 and 512.

Wallet service provider electronic device CPU 352, through wallet service provider software 366, allows wallet service provider electronic device 350 to communicate with receiver's wallet electronic device 500. The communication between wallet service provider electronic device 350 and receiver's wallet electronic device 500 allows the sending and receiving of information between the two including information contained in databases 344. Wallet service provider software 366 operating on wallet service provider electronic device CPU 352 accesses databases 344 to receive information from and send information to receiver's wallet electronic device 500 through network interfaces 362 and 512.

The user, through receiver's wallet electronic device 500, may cause wallet service provider electronic device 350, either directly or through input which is processed by the instructions stored on wallet service provider electronic device hard drive/persistent storage device 356, to send or obtain information or other relevant data to or from remote electronic devices 14, 250, 290, 300, and 400 through network interfaces 362 and 512.

Verification service electronic device 400 may have any or all of the following: verification service electronic device CPU 422, verification service electronic device RAM 424, verification service electronic device hard drive/persistent storage device 426, verification service electronic device display 428, verification service electronic device input device 430 (which can include a keyboard, mouse, or touch screen, but any suitable input device can be used and is encompassed by this disclosure), verification service electronic device network interface 432, verification service electronic device printer 434, and verification service electronic device camera or scanner 436.

Verification service electronic device 400 either has one or more databases 440 stored on its verification service electronic device hard drive/persistent storage device 426 or has access to one or more remote databases 440. Verification service electronic device CPU 422 causes the instructions of verification service software 438, which are stored on hard drive/persistent storage device 426, to be read into verification service electronic device RAM 424 and then executes them to allow verification service electronic device 400 to receive information from and send information to wallet service provider electronic device 350 through network interfaces 362 and 432.

Verification service electronic device CPU 422, through wallet service provider software 366, allows wallet service provider electronic device 350 to communicate with verification service electronic device 400. The communication between wallet service provider electronic device 350 and verification service electronic device 400 allows the sending and receiving of information between the two, including information contained in databases 440 through network interfaces 362 and 432. Verification service software 438 stored on verification service electronic device CPU 422 accesses databases 440 to receive information from and send information to wallet service provider electronic device 350.

Wallet service provider electronic device CPU 352, through wallet service provider software 366, allows wallet service provider electronic device 350 to communicate with verification service electronic device 400. The communication between wallet service provider electronic device 350 and verification service electronic device 400 allows the sending and receiving of information between the two including information contained in databases 344 and 440. Wallet service provider software 366 operating on wallet service provider electronic device CPU 352 accesses databases 344 to receive information from and send information to verification service electronic device 400 through network interfaces 362 and 432.

Financial institution electronic device 300 may have any or all of the following: financial institution electronic device CPU 322, financial institution electronic device RAM 324, financial institution electronic device hard drive/persistent storage device 326, financial institution electronic device display 328, financial institution electronic device input device 330 (which can include a keyboard, mouse, or touch screen, but any suitable input device can be used and is encompassed by this disclosure), financial institution electronic device network interface 332, financial institution electronic device printer 334, and financial institution electronic device camera or scanner 336.

Financial institution electronic device 300 either has one or more databases 338 stored on its financial institution electronic device hard drive/persistent storage device 326 or has access to one or more remote databases 338. Financial institution electronic device CPU 322 causes the instructions of financial institution software 342, which are stored on financial institution electronic device hard drive/persistent storage device 326, to be read into financial institution electronic device RAM 324 and then executes them to allow financial institution electronic device 300 to receive information from and send information to wallet service provider electronic device 350 through network interfaces 332 and 362.

Wallet service provider electronic device CPU 352, through wallet service provider software 366, allows wallet service provider electronic device 350 to communicate with financial institution electronic device 300. The communication between wallet service provider electronic device 350 and financial institution electronic device 300 allows the sending and receiving of information between the two, including information contained in databases 338 and 344 through network interfaces 332 and 362. Financial institution software 342 stored on financial institution electronic device CPU 322 accesses databases 338 to receive information from and send information to wallet service provider electronic device 350.

Sender's wallet electronic device 14 and receiver's wallet electronic device 500 may have their own databases stored on their respective hard drives/persistent storage devices 226 and 506 or have access to external databases, and while they are not mentioned specifically, they function in the same manner of the previously described databases.

Any or all of electronic devices 14, 250, 290, 300, 350, 400, or 500 may have a graphical user interface to allow interaction between a user and the electronic device. Examples of graphical user interfaces include, but are not limited to, those depicted in FIGS. 8a through 10b.

Software 10, 272, 280, 342, 366, 438, and 518 includes both the software that is specific to the wallets 10 and 518 of this invention and the general software on electronic devices 14, 250, 290, 300, 350, 400, or 500 that run the operating system and other functions of the electronic devices and all such software is encompassed by this disclosure.

Any form of network interface 232, 262, 286, 332, 362, 432, or 512 can be used and is encompassed by this disclosure. The network interface can include, but is not limited to, a network interface card or software, a local area network (LAN) or a wide area network (WAN), Wi-Fi® and Ethernet, wired, or wireless, and all appropriate network interfaces are encompassed by this disclosure.

One example of Wi-Fi can be found under the United States Trademark Registration Wi-Fi, a registered certification mark of Wi-Fi Alliance, a corporation organized under the laws of California, 10900-B Stonelake Boulevard, Suite 126 Austin, Tex., 78759 with Registration Number 2,525,795.

The above disclosure is exemplary of the configuration and function of electronic devices 14, 250, 290, 300, 350, 400, or 500 but any suitable function of 14, 250, 290, 300, 350, 400, or 500 may be used and all such suitable functions are encompassed by this disclosure.

### Method

The method is identified in stages as wallet on-boarding process 20, wallet transaction process 24, financial institution linking process 26, wallet maintenance and security process 28, and wallet opening screening process 34 and each of these stages comprise the following individual steps. As will be obvious to persons of ordinary skill in the art, the steps, or steps equivalent thereto, may be practiced in any reasonable order which will produce the desired result.

The wallet service provider electronic device 350 (herein after wallet service provider) is the clearing house of all information that is transferred between electronic devices 14, 250, 290, 300, 400, and 500. Wallet service provider activates and de-activates wallets 10 and 518, provides for logging in to wallets 10 and 518, approves or denies transactions, stores user information, and facilitates the wallet to financial institution interface 16 to financial institution electronic device 300. Input from devices 250, 290 and 400 allow wallet service provider to perform the security functions of this invention. The wallet service provider is the host of the wallets 10 and 518 and wallet service provider software 366.

It is preferred, but not required, that anytime any information (of any kind mentioned in this disclosure) is sent between electronic devices 14, 250, 290, 300, 350, 400, and 500 that it be sent in encrypted format through the use of any suitable software or other device or method.

Throughout the remaining specification, electronic devices 14 and 500 and wallets 10, 10a, 10b, 518, 518a, and 518b are used. These are used for clarity based on the preceding paragraphs. It is inherent that the only difference between the electronic devices and wallets of this invention of the sender's side 10, 10a, 10b, and 14 and the receiver's side 500, 518, 518a, and 518b is the side of a particular crypto asset transaction. And, any of 10, 10a, 10b, and 14 and 500, 518, 518a, and 518b can be interchangeable as sender's side and receiver's side.

The wallet service provider may store any information provided to it via wallets 10 or 518 or any other electronic device or third party service provider (screening service 50 or third party verification service 60) in databases 344. The wallet service provider may store any information provided to it in databases 344 or may access any necessary information contained in databases 344.

### Wallet Pre-Activation/On-Boarding Stage

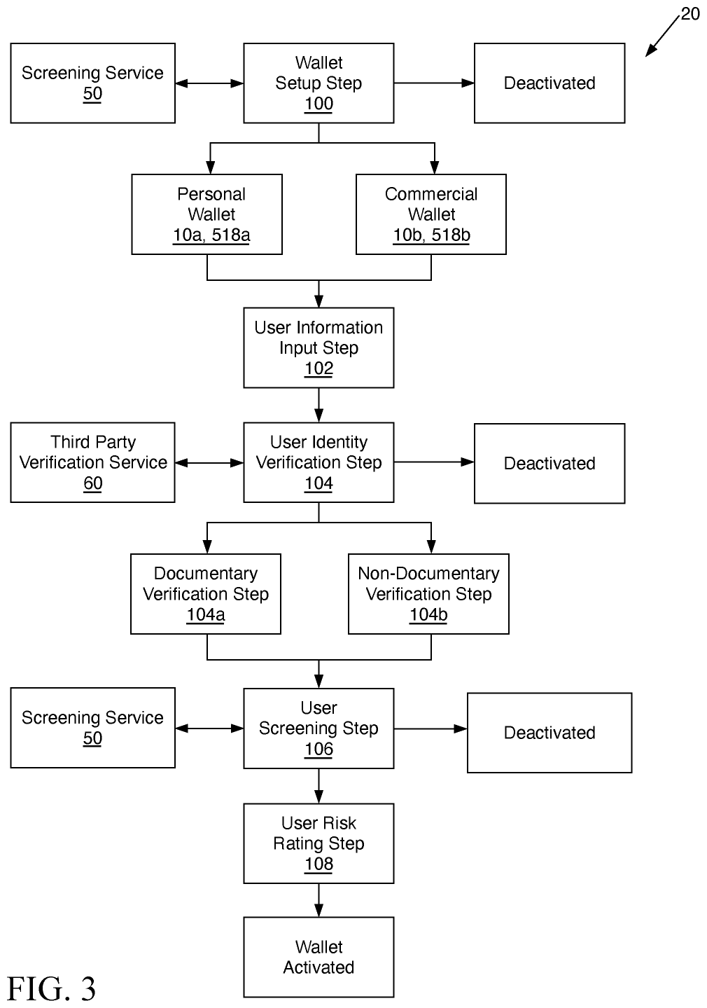

Now adding FIG. 3, FIG. 8a, FIG. 8b, and FIG. 8c to the consideration, the wallet on-boarding process 20 can be clearly seen. STEP 100 through STEP 108 are included in the wallet on-boarding process 20. STEP 100 is the Wallet Setup Step. In STEP 100, the user's wallet 10 or 518 is created. This can be done by entering an email address or other user identification and a password. The user can also select whether a personal wallet 10a or 518a or a commercial wallet 10b or 518b will be created (collectively “wallet 10 or 518” and further defined in STEP 102). Or, the wallet setup STEP 100 can be accomplished by any other suitable method and all such methods are encompassed by this disclosure.

In STEP 100, a wallet identification 22 may be created by the wallet service provider for the wallet 10 or 518. The wallet identification 22 will be communicated to the user by the wallet service provider in any suitable fashion including, but not limited to, email communication. Once the wallet identification 22 is created, it and a password may be required to login to the wallet 10 or 518. It is preferred that the wallet identification 22 be emailed to the user and the user confirm to the wallet service provider that the email address that receives the wallet identification 22 is the correct email address to associate with wallet 10 or 518. If the user ever forgets their wallet identification 22, the email address associated with the wallet 10 or 518 may be used by the wallet service provider to provide login credentials for wallet 10 or 518. The wallet identification 22 and password is just one option for the method of accessing wallet 10 or 518 and any suitable option can be used and is encompassed by this disclosure.

In STEP 100, a private key is created by the wallet service provider. Once the private key is created, it preferably will be communicated to the user, through wallet 10 or 518, one time. It is preferred, that the user write down or otherwise memorialize the private key or the user will not be able to access the private key in the future. This allows the private key to only be known by the wallet 10 or 518, the wallet service provider (and it may be stored in databases 344) and the user, if the user records the private key (and the private key will be used in process 24).

A private key is preferably a combination of alphanumeric characters, a piece of software code, or any other form of numbers, letters, or symbols that is used to protect a user's cryptocurrency. A user name and password may be used to access the wallet 10 or 518 of this invention, but a private key is needed to send, receive, withdraw, or otherwise transfers crypto assets.

In STEP 100, once the wallet 10 or 518 is accessed, the Internet Protocol address (hereinafter “IP address”) of the electronic device 14 or 500 on which the wallet 10 or 518 is accessed is sent to a screening service 50 by the wallet service provider (the IP addresses may be stored on databases 344). The screening service 50 determines the origination of the IP addresses through its access to databases 268, if the wallet 10 or 518 was accessed on an electronic device 14 or 500 located in a disallowed area and if so, wallet 10 or 518 is deactivated by the wallet service provider. If not, process 20 proceeds to the next step.

The screening service 50 is preferably a computer program, software, or software application (but can be a human analyst) that identifies the IP address and analyzes the location from which the IP address originates. If the IP address of the electronic device 14 or 500 on which the wallet 10 or 518 is accessed originates from a disallowed location, the screening service 50 flags the login. Screening service 50 will make an initial determination: either the wallet 10 or 518 was accessed on an electronic device 14 or 500 which is not in a disallowed location and this information is sent to the wallet service provider and the use of wallet 10 or 518 continues. Or, wallet 10 or 518 was accessed on an electronic device 14 or 500 that is in a disallowed location or a location that cannot be clearly identified and this information is sent to the wallet service provider who deactivates the wallet 10 or 518 or sends requests for further review to the screening service 50.

Screening service 50 may have further ways to screen flagged IP addresses of electronic device 14 or 500 on which wallet 10 or 518 was accessed to address potential false positives (a false positive is an IP address that is flagged as originating from a disallowed location when the IP address does not originate from a disallowed location). For example, either a further computer program, software, software application, or a human analyst can look at the IP address from the electronic device 14 or 500 on which wallet 10 or 518 was accessed and further determine that the IP address does not originate from a disallowed location and sends this information to the wallet service provider which allows the wallet 10 or 518 to continue forward in process 20.

Screening service 50 must be able to clearly identify the location from which the IP address of the electronic device 14 or 500 that is being used to access wallet 10 or 518 originates. If the IP address is not clearly identifiable either due to technical issues or the use of routers or equipment (for example, the onion router “Tor router”) to make the location ambiguous or not ascertainable, the wallet service provider will deactivate the wallet 10 or 518 until it is accessed on an electronic device 14 or 500 with an identifiable IP address which does not originate in a disallowed location.

STEP 102 is the User Information Input Step. In STEP 102, the user provides identifying information 12 about themselves. The wallet 10 or 518 cannot be activated or on-boarded until the user provides all of the user information 12 required by wallet 10 or 518 through the wallet service provider (and user information 12 may be stored in databases 344).

This step will be discussed for two different wallet types: a personal wallet 10a or 518a and a commercial wallet 10b or 518b. A personal wallet 10a or 518a is for use by an individual user who is a single, individual, identifiable person. The individual user can be more than one person, but each person within the group must be an individual, identifiable person. Throughout this disclosure, the user (either the user for wallet 10a or 518a or a signatory user for wallet 10b or 518b) will be treated as a single, identifiable person, but this is exemplary only and not meant to limit the disclosure in any manner.

On the other hand, a commercial wallet 10b or 518b is for use by an entity user who is an institution, a corporation or other legal entity, a civic or a government organization, or any other entity that is not a single, identifiable, individual person (hereinafter “entity”).

For personal wallet 10a or 518a, the user information 12 required to activate the wallet 10a or 518a can include the following information: the user's first name, last name, date of birth, government issued identification number (such as a social security number), country of residence, country of citizenship, and their address including street name, city, state or region, country, and postal code. The requirements for user information 12 can vary depending upon the country of residence and the user information 12 requirements to activate wallet 10a or 518a can reflect the differences in address or other information 12 across different countries or geographical regions. This list is meant to be exemplary of user information 12 and any suitable information is encompassed by this disclosure.

For commercial wallet 10b or 518b, the user information 12 required to activate the wallet 10b or 518b can include the following information: the full legal name of the entity with any status identifiers (Corp., LLC, LLP, etc.), a government issued identification number (such as an Employer Identification Number), and address including street name, city, state or region, country, and postal code. The requirements for the user information 12 can vary depending upon the country of residence (i.e. a corporation of the United States of America, a limited liability company of Italy) and the user information 12 requirements to activate wallet 10b or 518b can reflect the differences in address or other information 12 across different countries or geographical locations. This list is meant to be exemplary of user information 12 and any suitable information is encompassed by this disclosure.

Also, wallet 10b or 518b, through wallet service provider, may require that the user enter information 12 about an individual signatory user who will act as a signatory on the wallet 10b or 518b and have access to and interact with the wallet 10b or 518b and its functionalities. The individual signatory user will be a single, individual, identifiable user or multiple single, individual, identifiable users. The information 12 required for each of the one or more individual signatory users will be similar to that for personal wallet 10a or 518a above.

Commercial wallet 10b or 518b, through wallet service provider, may require users to upload articles of incorporation, articles of organization, or other entity formation paperwork, and disclose material owners with a certain percentage of ownership in the entity. For example, a wallet 10b or 518b, through wallet service provider, may require the disclosure of material owners with a ten percent or more share or interest in the entity and ten percent is used as an example and not meant to limit the scope of the disclosure and any suitable percentage or denomination can be utilized. If the material owners are individuals, then the user information 12 will be similar to the information 12 for personal wallet 10a or 518a as stated above.

However, if the material owners are entities, then the user information 12 will be similar to that stated above for the entity associated with commercial wallet 10b or 518b and include disclosing the material owners holding a ten percent share or more of the secondary entity. The process for material owners that are entities will continue until all of the material owners have been associated with one or more single, identifiable, individuals.

It is preferred that a government issued photographic identification card (hereinafter “photo id”) be provided to the wallet service provider through wallet 10 or 518 in this STEP 102 and the photo id may include a driver's license or other government issued identification card (the photo id may be stored in databases 344). For a wallet 10a or 518a, each individual user preferably uploads a photo id into the wallet service provider electronic device 350 through wallet 10a or 518a. For a wallet 10b or 518b, each individual signatory user uploads a photo id into wallet service provider electronic device 350 through wallet 10b or 518b. Also, for wallet 10b or 518b, each individual material owner preferably uploads a photo id into wallet service provider electronic device 350 through wallet 10b or 518b.

Throughout this disclosure the term “user” is utilized. The term user is meant to encompass either an individual user for wallet 10a or 518a, an entity user associated with wallet 10b or 518b, or a signatory user for wallet 10b or 518b unless otherwise specified or it is impossible to include all three. For example, it is impossible to take a photo of an entity for verification purposes and the entity user is not included in the user for these references.

STEP 104 is the User Identity Verification Step. In STEP 104, the identify of user of wallet 10 or 518 is verified by the wallet service provider with or without the third party verification service 60 using the information 12 provided in STEP 102. The user verification can be accomplished by any suitable method, including the methods below, and all such methods are encompassed by this disclosure. If the user's identity is not verified in STEP 104, wallet 10 or 518 is deactivated by the wallet service provider. If the user's identity is verified by the wallet service provider either with or without the third party 685 verification service 60, process 20 proceeds to the next step.

STEP 104a is an optional Documentary Verification Step. Wallet 10 or 518 can utilize the camera 236 or 516 on electronic device 14 or 500 and artificial intelligence facial recognition software (may be included in software 366) on wallet service provider electronic device 350 to compare the photo on the photo id with the photo taken on the camera 236 or 516 of electronic device 14 or 500 and verify that the user who is creating the wallet 10 or 518 is the user who appears on the government issued photo id uploaded to wallet service provider electronic device 350 through wallet 10 or 518 in STEP 102. The photo of the user's face (either an individual user or a signatory user) taken from the camera 236 or 516 on electronic device 14 or 500 can be stored in wallet service provider electronic device 350 for later use (and the photo may be stored in databases 344).

STEP 104b is an optional Non-Documentary Verification Step. If a government issued photo id is not provided in STEP 102, wallet 10 or 518 can still utilize the camera 236 or 516 on electronic device 14 or 500 and create a photo of the user who is creating wallet 10 or 518 which is stored on wallet service provider electronic device 350 (and the photo may be stored in databases 344), but other verification techniques have to be utilized. For example, the remaining user information 12 provided in STEP 102 can be sent to a third party verification service 60. The third party verification service 60 is preferably a computer program, software, or a software application that verifies the identify of individual users, signatory users, and entity users based upon personal or business information 12 provided to it by the wallet service provider electronic device 350 such as name, government issued identification number, and address and then, searches and validates the identity of the user and the information 12 against one or more public and private data sources or databases 440.

An example of a third party verification service 60 is Experian®. Experian is a registered trademark with United States Trademark Registration Number 2,260,187, owned by Experian Information Solutions, Inc., a corporation organized under the laws of the state of Ohio, 475 Anton Boulevard, Costa Mesa, California, 92626 (among others). This is just one example of third party verification service 60 and any appropriate third party verification service 60 can be utilized and is encompassed by this disclosure.

It is preferred that the information 12 is encrypted before is sent to the third party verification service 60. The third party verification service 60, through its computer programs, software, software applications, and computers, will use information 12 and match it against the records it has for the user through databases 440. However, a photo of the user (either an individual user or a signatory user) is still taken using the camera 236 or 516 on electronic device 14 or 500 and stored on the wallet service provider electronic device 350 for later use (and the photo may be stored in databases 344).

If in either STEP 104, STEP 104a, or STEP 104b, the information (including photos) 12 cannot be validated by either method, the user may be prompted by the wallet service provider electronic device 350 to correct any information 12 that may be incorrect or to provide more or different information 12 so that the user's identity can be validated.

If the user's identity is not validated in STEP 104, STEP 104a, or STEP 104b, even after the correction of incorrect information 12 or the addition of more or different information 12, the wallet 10 or 518 will be deactivated by the wallet service provider. If the user's identity can be validated by the wallet service provider electronic device 350, with or without the third party validation service 60, either with the initial information 12 or corrected or additional information 12, wallet 10 or 518 will not be deactivated and process 20 will continue.

STEP 106 is the User Screening Step. In STEP 106, if the user's identity was validated in STEP 104, the screening service 50 will enter the user's name and other identifiable information 12, provided by the wallet service provider, into one or more databases 268 (or compared against any other suitable form of the disallowed list such as paper lists and all such forms are encompassed by this disclosure) containing information regarding individuals or entities on disallowed lists. Information 12 that was entered in STEP 102 or added in STEP 104 is sent to a screening service 50 by the wallet service provider and the screening service 50 will attempt to determine if the user is listed on a disallowed list and if so, the wallet will be not be able to be activated by the wallet service provider. It is preferred that the information 12 is encrypted as it is sent to the screening service 50.

If the screening service 50 identifies the user as being on a disallowed list, the wallet 10 or 518 is deactivated by the wallet service provider. If the screening service 50 determines that the user is not on any disallowed list, process 20 continues to the next step.

As discussed previously, if the screening service 50 identifies a user as being on a disallowed list, the user's name and other identifiable information 12 may be sent by the wallet service provider to the screening service 50 for a secondary review. The further review may be conducted by a computer program, software, a software application, or it may be conducted by a human being. If at the end of the secondary review, the user can be identified as not being on any disallowed list and the initial determination was a false positive, the wallet 10 or 518 may not be deactivated by the wallet service provider and the process 20 may continue. Otherwise, if the user is identified as being on a disallowed list or cannot be clearly identified as not being on a disallowed list by the screening service 50, the wallet 10 or 518 is deactivated by the wallet service provider.

STEP 108 is the User Risk Rating Step. In STEP 108, the user is given a risk rating by the wallet service provider based on the information 12 provided in STEP 102 and further information 12 that may be provided in other steps. The user's risk rating can be based on all or part of the information 12 that is provided in STEP 102 or corrected or added in other steps. The user is not able to view the user's risk rating and only the wallet service provider knows the user's risk rating (the risk rating may be stored databases 344).

STEP 108 uses information 12 provided in earlier steps. However, the information 12 needed for STEP 108 may vary from jurisdiction to jurisdiction. Some jurisdictions may require more or different information 12 and this information 12 can be added in any step and can allow for the addition of new information 12 to provide a risk rating in compliance with the laws of specific jurisdictions.

The risk rating can be in any measurement or graduated step. In the example below, the risk ratings are high, medium, and low. However, this is only meant to be an example and is not meant to limit the scope of the disclosure in any manner.

A user's risk rating will affect their interaction with wallet 10 or 518. Based on a risk rating, the user may have to periodically take steps after the wallet 10 or 518 is activated to confirm identity or to provide other information 12 or take other steps to ensure the security of wallet 10 or 518.

For example, an individual or entity user may be rated as a high, medium, or low risk by the wallet service provider. A high risk commercial or individual user may be required by the wallet service provider to confirm that information 12 is accurate and update information 12 on an annual basis. If a commercial user is rated as a medium risk, the commercial user may be required to confirm that information 12 is accurate and update information 12 every two years. If a commercial user is rated as a low risk, it may only be required to confirm that information 12 is accurate and update information 12 every three years. Individual users who are rated as a medium or low risk may not be required to confirm or update their information 12. If in any of the above risk rating scenarios new information 12 is entered, the process 20 may revert to STEPS 104 to 108 to ensure the security of wallet 10 or 518 as determined by the wallet service provider.

Once STEP 108 has been successfully accomplished, then wallet 10 or 518 is activated by the wallet service provider and ready for use.

### Wallet Post-Activation Stage

Once the user has completed the steps in the pre-activation or on-boarding stage, wallet 10 or 518 is activated by the wallet service provider. The user is now free to utilize wallet 10 or 518 to buy, sell, transfer, or otherwise manage their crypto assets.

STEP 110, STEP 112, and STEPS 114 to 120 are not necessarily steps that are meant to proceed in a linear, chronological order to each other. STEPS 114 to 120 may proceed in a linear, chronological order amongst themselves, but do not necessarily do so in relation to STEP 110 and STEP 112. STEP 112 details steps that occur in process 34 every time wallet 10 or 518 is opened. STEPS 114 to 120 detail steps that occur when a user wants to send, receive, or otherwise transfer crypto assets. A user may open wallet 10 or 518 and thus, engage in STEP 112, but may not necessarily want to send, receive, or otherwise transfer crypto assets and thus, not engage STEPS 110 and 114 to 120. As is inherent, a user cannot engage in STEPS 114 to 120 without first engaging in STEP 112.

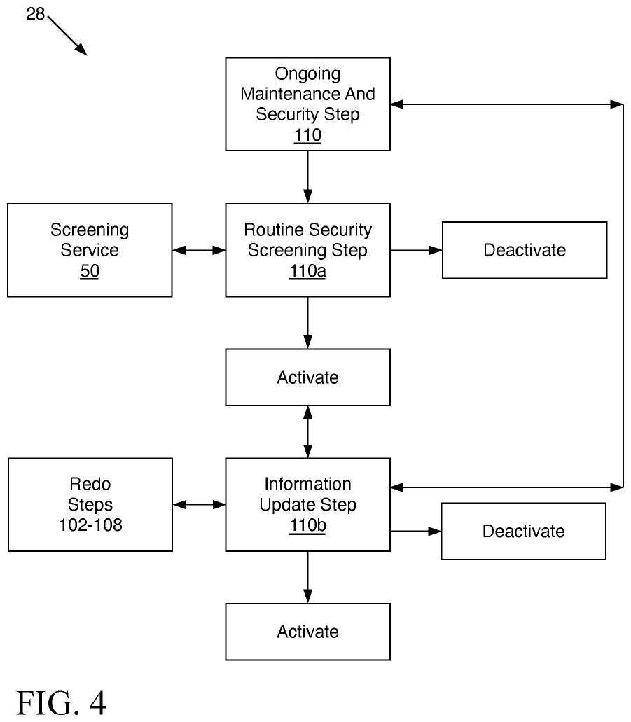

Now adding FIG. 4 to the consideration, the wallet maintenance and security process 28 can be clearly seen. STEP 110 is the Ongoing Maintenance and Security Step. In STEP 110, activities are conducted at routine intervals that aid in promoting the security of wallet 10 or 518.

STEP 110a, is an optional Routine Security Screening Step. Information 12 is preferably encrypted and sent to screening service 50, by the wallet service provider, on a daily basis, although any suitable time period or interval can be used and is encompassed by this disclosure, and for the following example a daily screening will be utilized. On a daily basis, information 12 is sent to screening service 50 by the wallet service provider and the screening service 50 screens the information 12 against the disallowed list through databases 268. It is preferred, for efficiency, that the information 12 only be screened against new information added to a disallowed list since the last screening. In this STEP 110a, if the user is identified as a match on the disallowed list by the screening service 50, the wallet 10 or 518 will be deactivated by the wallet service provider and will not be reactivated until it is confirmed that the screening service 50 has made an erroneous match or the user is no longer on the disallowed list.

STEP 110b, is the Information Update Step and includes STEP 110, STEP 110a, and STEP 110b. In STEP 110b, any time the user address associated with wallet 10 or 518 changes, the new information 12 (preferably including unchanged information 12 and updated information 12) is sent to the screening service 50 by the wallet service provider. The new information 12 (and potentially the unchanged information 12) is screened against the entirety of the disallowed list by the screening service 50 through it access to databases 268 as in STEP 106. In this STEP 110b, if the user is identified as a match on the disallowed list by the screening service 50, the wallet 10 or 518 will be deactivated by the wallet service provider and will not be reactivated until it is confirmed that the screening service 50 has made an erroneous match or the user is no longer on the disallowed list.

It is preferred that anytime a user first name, a user last name, an entity name, or a government-issued identification number changes, STEPS 102 to 108 are redone with the new information 12 (and potentially any existing information 12 that has not changed).

If a new signatory is added, (usually for a wallet 10b or 518b but, can be for a wallet 10a or 518a) after the wallet 10 or 518 has been activated, STEPS 102 to 108 are redone for the new signatory.

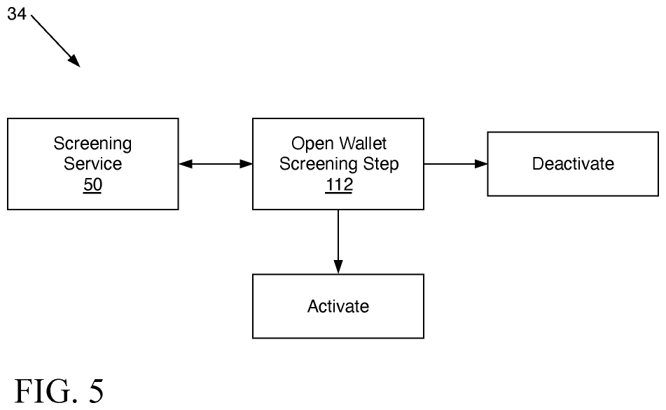

Now adding FIG. 5 to the consideration, the wallet opening screening process 34 can be clearly seen and includes STEP 112. STEP 112 is the Open Wallet Screening Step. In STEP 112, anytime that wallet 10 or 518 is opened there are security measures that are performed. When the wallet 10 or 518 is opened, the IP address of the electronic device 14 or 500 that the wallet 10 or 518 is opened on is sent to a screening service 50 by the wallet service provider. Screening service 50, through its access to databases 268 which have the disallowed list (or any other suitable method), will determine the current location of the user of the wallet 10 or 518 (and the wallet 10 or 518 if it is a hardware wallet) based on the origin of the IP address of the electronic device 14 or 500 on which the wallet 10 or 518 is opened. If the IP address indicates that the user or the wallet 10 or 518 is in a disallowed location, the wallet 10 or 518 will be deactivated by the wallet service provider until the electronic device 14 or 500 that the wallet 10 or 518 is opened on is not in a disallowed location as determined by the screening service 50.

As discussed previously, if the initial determination of the screening service 50 is that the IP address of the electronic device 14 or 500 on which wallet 10 or 518 is opened originates from a disallowed location, the wallet service provider may request that the IP address be sent for secondary review by the screening service 50. The secondary review may be performed by a computer program, software, a software application, or it may be performed by a human being. If at the end of the secondary review, the screening service 50 can identify that the IP address of the electronic device 14 or 500 on which the wallet 10 or 518 is opened does not originate from a disallowed location, the wallet 10 or 518 may not be deactivated by the wallet service provider and process 34 may continue. Otherwise, if the screening service 50 cannot clearly identify the origin of the IP address for the electronic device 14 or 500 on which the wallet 10 or 518 was opened or if the IP address is identified as being in a disallowed location, wallet 10 or 518 is deactivated by the wallet service provider and cannot be reactivated until the wallet 10 or 518 is confirmed by the screening service 50 to have been opened in a location that is not on a disallowed list.

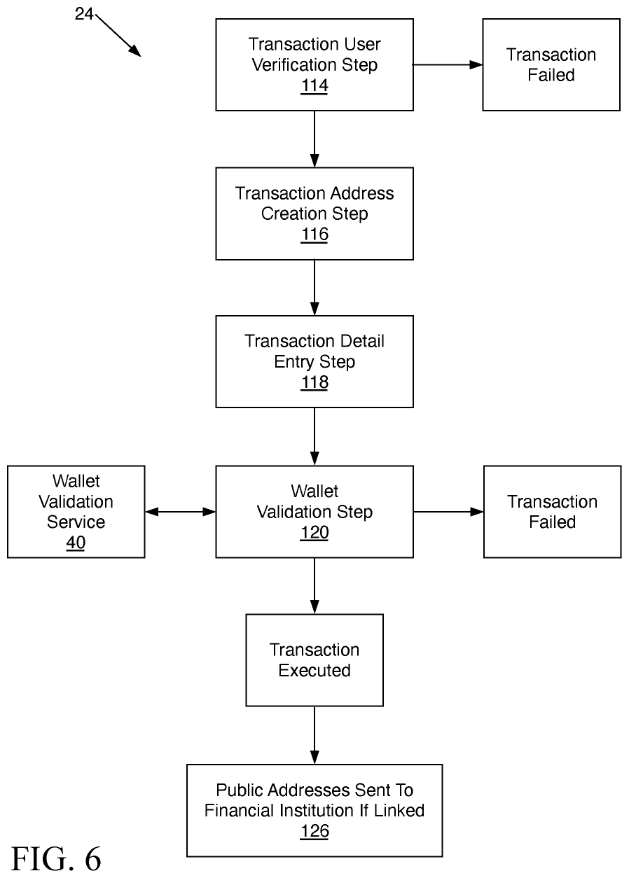

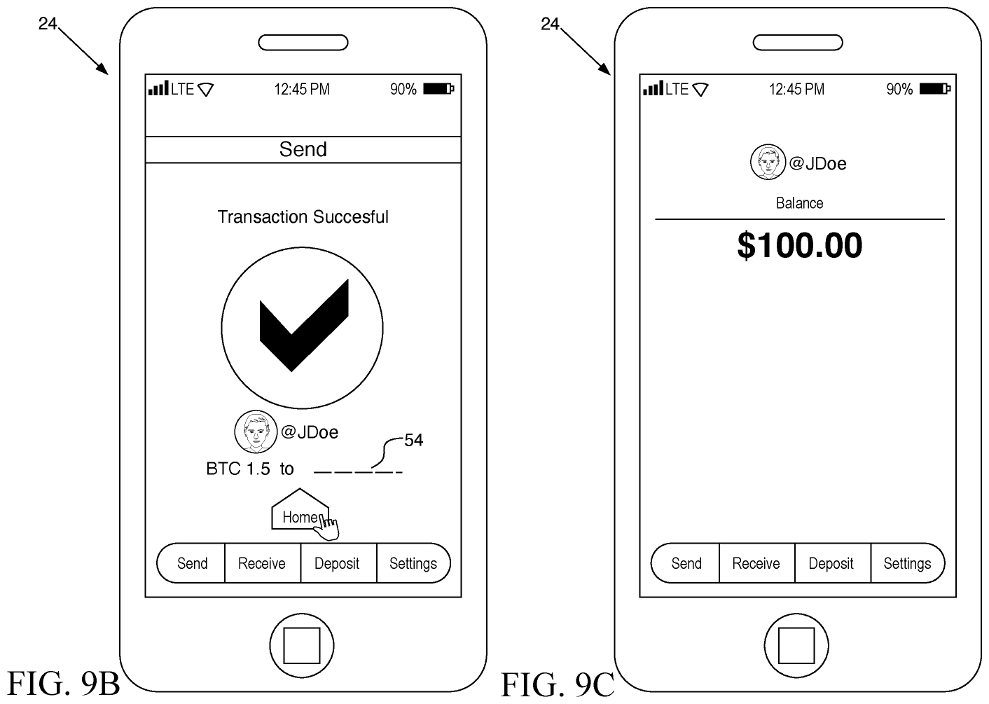

Now adding FIG. 6, FIG. 9a, FIG. 9b, and FIG. 9c to the consideration, the wallet transaction process 24 can be clearly seen and includes STEP 114 to STEP 120. STEP 114 is the Transaction User Verification Step. In STEP 114, before any transaction can occur, wallet 10 or 518 will use the camera 236 or 516 on electronic device 14 or 500 to photograph the user.

Wallet service provider, through wallet 10 or 518, must verify that the user is the individual user who created wallet 10a or 518a or a validated signatory user for wallet 10b or 518b. Wallet service provider can use artificial intelligence facial recognition software (may be included in wallet service provider software 366) to compare the new photo to the photo on file and the photo on file can be a photo from a government issued photo id or a photo on file from earlier interactions with wallet 10 or 518.

If the user's identify cannot be verified in STEP 114, the wallet service provider does not allow the transaction to occur and ends after the failed user identity verification. If the user's identity can be verified, process 24 proceeds to the next step.

STEP 116 is the Transaction Address Creation Step. In this STEP 116, both the sender and the receiver request that their respective wallets 10 or 518 create a public address 54 (i.e. a sender public address and a receiver public address). Wallet 10 or 518 of this invention uses an algorithm 280, and the wallet's private key, to create the public addresses 54 and the public addresses 54 have unique identifiers that are specific to wallet 10 or 518. The receiver of the crypto assets communicates the receiver public address 54 to the sender through any appropriate means.

STEP 118 is the Transaction Detail Entry Step. In this STEP 118, the sender of the crypto assets enters the details of the transaction into sender's wallet 10. The details of the transaction can include, the type of crypto assets, the amount of crypto assets, the public address 54 of the receiver of the crypto assets, and any other information that is necessary to complete the crypto assets transaction.

STEP 120 is the Wallet Validation Step. Wallet service provider will receive the receiver's public address 54 and the sender's public address 54 and send them (preferably with encryption) to a wallet validation service 40 (public addresses 54 may be stored on databases 344). The wallet validation service 40 will confirm, through its databases 42 and/or software 289, that both the sender's public address 54 and the receiver's public address 54 are unique and have not been used in a previous transaction, and that each address was generated by a wallet 10 or 518 or a third party wallet that meets the standards set forth by wallet 10 or 518 (wallet service provider can set the standards of identification, verification, security, and any other desired standard and all such standards are encompassed by this disclosure). A wallet validator algorithm 280 will determine if the sender's public address 54 and the receiver's public address 54 were created by a wallet 10 or 518 or a third party wallet which meets the standards of wallet 10 or 518.

The sender's public address 54 and the receiver's public address 54 do not have to be created by a wallet 10 or 518. But, each wallet 10 or 518 must have an address that is created by a wallet 10 or 518 or by a third party wallet that uses the same security features and meets the same regulatory, compliance, or other legal standards as dictated by wallet service provider.

The wallet validation service 40 will then send a message back to the wallet service provider (preferably with encryption) and either confirm that both addresses 54 were created by a wallet 10 or 518 or an acceptable third party wallet and in that case, the transaction will be executed. Or, the wallet validation service 40 will specify that one of the sender public address 54 or the receiver public address 54 is not from a wallet 10 or 518 or an acceptable third party wallet and in that case, the sender will be alerted by the wallet service provider that the transaction cannot be executed.

It is optional for wallet validation service 40 to charge a fee for its services. The fee can be deducted from either or both of the sender's or receiver's wallet 10 or 518 and a reflection of this deduction can be noted in either or both of the sender's or receiver's crypto asset balance. It is also optional for the other third party services of this invention (screening service 50 or third party verification service 60) to charge a fee in the same manner.

This STEP 120 ensures that the transaction occurs between two (or possibly more) wallets 10 or 518 or acceptable third party wallets that meet the pre-established security and identification standards listed earlier in this disclosure. Both the sender and receiver will have had their identities verified through the process 20 or a similar third party procedure. Also, both the sender and receiver will have to revalidate their identities before the transaction 960 is allowed to proceed.

### Optional Financial Institution Steps

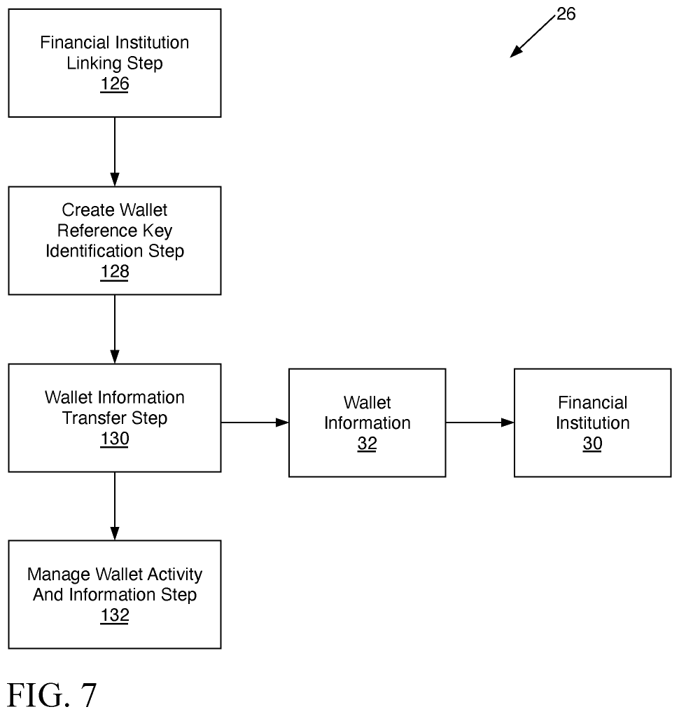

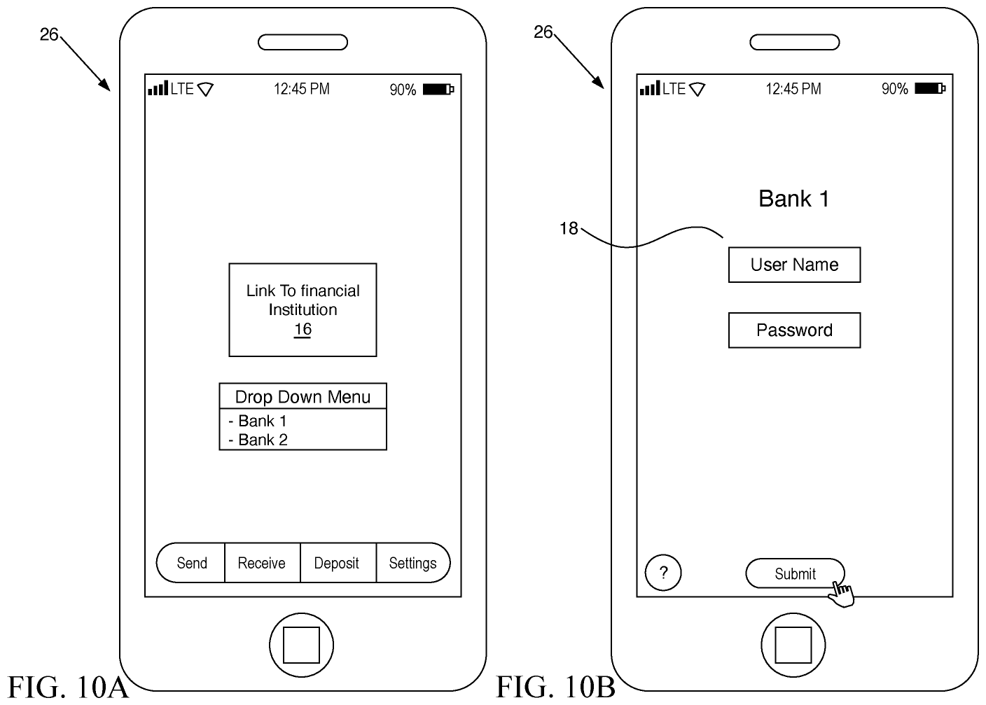

Now adding FIG. 7, FIG. 10a, and FIG. 10b to the consideration an optional financial institution linking process 26 can be clearly seen and includes STEP 126 to STEP 132. Throughout these STEPS 126 to 132, financial institution 30 is meant to include both the financial institution entity (for example, the particular bank and its financial institution electronic device 300).

In optional Financial Institution Linking STEP 126, optional features and functions of wallet 10 or 518 are described. These optional features may be used if a user wants to link the wallet 10 or 518 to their financial institution 30.

The user can link the wallet 10 or 518 to a financial institution 30 through the wallet service provider. The wallet 10 or 518 (which can either be wallet 10a or 518a or wallet 10b or 518b) will have a wallet to financial institution interface 16 and through interface 16 the user will input financial institution information 18 into wallet 10 or 518 and this information 18 will be sent, preferably in encrypted format, to the wallet service provider and then, to the financial institution 30, and also preferably in encrypted format (information 18 may be stored on databases 344). It is preferred that the financial institution information 18 be inputted into wallet 10 or 518 by the user entering their financial institution login information when prompted to do so (see FIG. 10b). Financial institution information 18 may include, the name of the financial institution, the address of the financial institution, account and routing numbers, and any other relevant information.

One option for linking to the financial institution 30 is through a drop down menu listing financial institutions in which the user selects their financial institution 30 from the list on the drop down menu (see FIG. 10a). Then, the user is directed to enter their financial institution login information 18 to connect wallet 10 or 518 to their financial institution 30 through the wallet service provider (see FIG. 8b). This is only one example of linking wallet 10 or 518 to the financial institution 30 and any suitable method can be used and is encompassed by this disclosure.

In the preferred embodiment, wallet 10 or 518 can only link to one financial institution 30 at a time. If the user wants to add another financial institution 30, the first financial institution link must be disconnected through the financial institution interface 16 and the wallet service provider and the user can repeat this STEP 126 and link to another financial institution 30 through wallet to financial institution interface 16 and the wallet service provider. Or, the user can create another wallet 10 or 518 and link that second wallet 10 or 518 to a new financial institution 30 through the wallet service provider and the user will have to redo STEPS 100 to 108 and STEP 126. This is especially useful, among other reasons, to prevent criminal, terrorist, or money laundering activity with crypto assets through the use of multiple wallets 10 or 518.

STEP 128 is the Create Wallet Reference Key Identification Step. In STEP 128, wallet 10 or 518 will generate a unique wallet reference key identification which serves as a unique identification value to identify wallet 10 or 518. Wallet reference key identification can be numbers, letters, symbols, or any other values which can create a unique key. Wallet reference key identification is different than the private key.

It is optional to generate the unique wallet reference key identification as a one way hash of some or all of the user information 12, the current date and time of the hash to the millisecond or some other time interval, and the wallet's private key. Wallet 10 or 518 can use any suitable hashing algorithm to create the hash.

STEP 130 is the Wallet Information Transfer Step. In STEP 130, wallet 10 or 518 will then encrypt wallet information 32, using any suitable encryption software, and send the wallet reference key identification, the user information 12, and the wallet information 32 to the wallet service provider (for any information 12 or 32 which has not already been sent to the wallet service provider and all information 12 or 32, the wallet reference key identification may be stored on databases 344) which then will send any or all of the information 12 and 32 to the financial institution 30. Thereafter, if any part of the user's information 12 changes, wallet 10 or 518 will automatically send any or all of the updated user information 12 as well as the wallet reference key identification to the financial institution 30, through the wallet service provider.

Only wallet 10 or 518, the wallet service provider, and any financial institution 30 that it is linked to it know the wallet reference key identification.

This is an important feature because as a user establishes a wallet 10 or 518, links it to a financial institution 30, and then, manages crypto assets, the wallet reference key identification will send information 32 to the financial institution 30 through the wallet service provider. The information 32, can include all public addresses 54 generated for use with wallet 10 or 518 and the type of crypto asset (i.e. Bitcoin) and any other information 32 related to wallet 10 or 518. The public addresses 54 will not be visible to the owner of wallet 10 or 518 (though the public addresses 54 will be on the block chain as part of the record of the transaction). Since the public addresses 54 are being sent with the wallet reference key identification, if the email or other form of preferably encrypted communication is intercepted, there is no personal private information that is compromised.

Wallet 10 or 518 will send all relevant information 12 related to the user to the financial institution 30, preferably in encrypted format, through wallet service provider. The information can include, but is not limited to, the user's risk rating as determined in STEP 108 and transactions of crypto currency related to the wallet 10 or 518.

It is preferred, but not required, that any information (12, 32, or otherwise) that the wallet 10 or 518 sends to the financial institution 30 be encrypted for security and privacy.

STEP 132 is the Manage Wallet Activity and Information Step. In this STEP 132, since the public address 54 is sent to the financial institution 30, through the wallet service provider, each time the wallet 10 or 518 is used to transact, send, receive, or manage crypto assets, the financial institution 30 can monitor and comply with its regulatory, reporting, tax, and compliance duties and send appropriate tax forms, if desired. The public addresses 54 combined with the wallet reference key identification will allow the financial institution 30, through its computers, computer programs, and software, to find and organize the activity of wallet 10 or 518.

During any step in processes 20, 24, 26, 28, or 34, if the wallet 10 or 518 is open and there has been no user activity for a given time period, the wallet 10 or 518 may log out, all transactions or activity may be cancelled, and the user will have to login to wallet 10 or 518 again to be able to use it.

### Wallet

Wallet 10 or 518 is a crypto asset wallet for sending, receiving, managing, and holding crypto assets. Wallet 10 or 518 has a series of unique features.

Wallet 10 or 518, through the wallet service provider, has user identity verification functions that aid wallet 10 or 518 in confirming that the user who is establishing the wallet 10 or 518 is who they identify as. Wallet service provider requires the user to input information 12 and then, confirms the user identity by comparing a photo taken with the camera 236 or 516 on the electronic device 14 or 500 to a pre-entered government issued photograph identification card (either an individual user for a wallet 10a or 518a or a signatory user of wallet 10b or 518b).

Or, the wallet 10 or 518, through the wallet service provider, uses the information 12 that is provided and cooperates with a third party verification service 60 to verify the identity of the user based on a comparison of the user information 12 and the information that the third party verification service 60 has on file or access to regarding the identity of the user through database 440. Wallet 10 or 518 can be deactivated by the wallet service provider if the identity of its user cannot be verified by system 200 and wallet 10 or 518 will remain deactivated until the identity of the user can be verified by system 200.

System 200 has a user screening feature and wallet 10 or 518 has a deactivation feature. System 200 is able to screen the user against various disallowed lists to minimize the chance of criminal, terrorist, or other nefarious activity through the use of wallet 10 or 518. Wallet service provider sends the information 12 to a screening service 50 and the screening service 50 compares the user information 12 against various disallowed lists it has on file or access to through databases 268 (or any other suitable form of database 268). If the user is matched as a person, entity, or group on a disallowed list, then the wallet 10 or 518 is deactivated by the wallet service provider until the user is no longer on the disallowed list or can establish that the match was a false positive through system 200.

System 200 has an IP address screening feature and wallet 10 or 518 has a deactivation feature. Wallet service provider can send the IP address of the electronic device 14 or 500 on which the wallet 10 or 518 is opened to the screening service 50 (the IP addresses may be stored on databases 344). If the screening service 50, through its access to databases 268, identifies the IP address as originating from a disallowed location or the screening service 50 cannot identify from where the IP address originates, then wallet 10 or 518 is deactivated by the wallet service provider until the electronic device 14 or 500 on which it is opened has an IP address that can be clearly identified as not originating from a disallowed location.

System 200 also has wallet validation features and wallet 10 or 518 has a deactivation feature. Wallet service provider uses a wallet validation service 40 to verify that both wallets 10 or 518 are wallets of this invention or third party wallets with equal pre-established security and identification features. The sender and receiver public addresses 54 are created through the sender and receiver wallets 10 or 518 and are created using a wallet algorithm 280 that creates public addresses 54 that can be verified to have been created by a wallet 10 or 518 of this invention or a suitable third party wallet. The public addresses 54 are sent to a wallet validation service 40 by the wallet service provider and the wallet validation service 40 will allow the transaction if the sender and receiver wallets 10 or 518 can be verified, by databases 42 and/or software 280, to be wallets 10 or 518 of this invention or acceptable third party wallets which use similar pre-established security and identification features. If the wallet validation service 40, through databases 42 or and/or software 280, cannot identify the wallets 10 or 518 as being wallets 10 or 518 of this invention or acceptable third party wallets 10 or 518, then the transaction fails.

Wallet 10 or 518 also has the ability to link to an account at a financial institution 30 through a financial institution interface 16 and the wallet service provider. In the preferred embodiment, wallet 10 or 518 can only link to one financial institution 30 (or its electronic devices 300) at a time and if the user wants to link to a second financial institution 30 (or its electronic devices 300), the user must disconnect from the first financial institution 30 (or its electronic devices 300) and link to the second financial institution 30 (or its electronic devices 300) or create a second wallet 10 or 518 to link to the second financial institution 30 (or its electronic devices 300).

Wallet 10 or 518 can also create wallet reference key identification which the financial institution 30 (or it electronic devices 300) can use to identify wallet 10 or 518. Due to the wallet reference key identification, the wallet 10 or 518 can send information 12 and wallet public addresses 54 and other wallet information 32, through the wallet service provider to the financial institution 30 (or its electronic devices 300) without sending personal protectable information of the user.

While various embodiments and aspects of the present invention have been described above, it should be understood that they have been presented by way of example only, and not limitation. Thus, the breadth and scope of the present invention should not be limited by any of the above exemplary embodiments.

This application—taken as a whole with the abstract, specification, claims, and drawings being combined—provides sufficient information for a person having ordinary skill in the art to practice the invention as disclosed herein. Any measures necessary to practice this invention are well within the skill of a person having ordinary skill in this art after that person has made a careful study of this disclosure.

Because of this disclosure and solely because of this disclosure, modification of this device, system, and method can become clear to a person having ordinary skill in this particular art. Such modifications are clearly covered by this disclosure.

1. A system and method for utilizing a crypto asset wallet with enhanced security features for verifying an identity of at least one user comprising:
a) at least four electronic devices, wherein each electronic device comprises a CPU, a RAM and/or a persistent storage device, a network interface, the RAM and/or the persistent storage device and the network interface operably connected to the CPU;
b) a set of software instructions for the crypto asset wallet with enhanced security features on a sender's wallet electronic device and a second set of software instructions on a wallet service provider electronic device, wherein the sender's wallet electronic device is one of the at least four electronic devices and the wallet service provider electronic device is one of the at least four electronic devices, and further wherein the sender's wallet electronic device has at least one input device and at least one display device, further wherein the set of software instructions on the sender's wallet electronic device including the sender's wallet;
c) entering at least one piece of user information though the at least one input device on the sender's wallet electronic device and sending this information to the wallet service provider electronic device;
d) validating an identity of the at least one user through the at least one piece of user information, wherein the validation can be performed by the wallet service provider electronic device or a verification service electronic device, further wherein the verification service electronic device has a third set of software instructions, further wherein the verification service electronic device is one of the at least four electronic devices, and further wherein the at least one piece of user information that has been validated is at least one piece of validated user information;
e) screening the at least one user based on the at least one piece of validated user information and the screening is performed by a screening service electronic device, wherein the screening service electronic device has a fourth set of software instructions, and further wherein the screening service electronic device is one of the at least four electronic devices; and
f) risk rating the at least one user based on the at least one piece of validated user information, wherein the risk rating is performed by the wallet service provider electronic device.

2. The system and method of claim 1 further comprising:
a) the sender's wallet electronic device having a camera to photograph the at least one individual human establishing the sender's wallet before the wallet service provider electronic device activates the sender's wallet, further wherein the sender's wallet sending the photograph to the wallet service provider electronic device;
b) the sender's wallet electronic device having a camera or scanning device to upload at least one photograph identification card to the wallet service provider electronic device as at least one piece of the at least one piece of validated user information; and
c) the wallet service provider electronic device software causing the wallet service provider electronic device to perform the following actions:
i. comparing the photograph taken by the camera on the sender's wallet electronic device with a photograph on the photograph identification card to verify the identity of the at least one individual human, wherein if the identity of the at least one individual human is verified, the wallet service provider electronic device does not deactivate the sender's wallet and if the identity of the at least one individual human is not verified, the wallet service provider electronic device deactivates the sender's wallet.

3. The system and method of claim 1 further comprising:
a) the wallet service provider electronic device cooperating with the verification service electronic device to verify the identity of the at least one individual human before the wallet service provider electronic device activates the sender's wallet by sending the at least one piece of validated user information to the verification service electronic device, wherein the verification service electronic device, though at least one verification service database, compares the at least one piece of validated user information to at least one piece of user information available to the verification service electronic device, through the at least one verification service database, regarding the at least one individual human, further wherein if the verification service electronic device can verify the identity of the at least one individual human through the comparison, the wallet service provider electronic device does not deactivate the sender's wallet, and if the verification service electronic device cannot verify the identity of the at least one individual human through the comparison, the wallet service provider electronic device deactivates the sender's wallet.

4. The system and method of claim 2 further comprising:
a) the screening service electronic device compares, prior to activation of the sender's wallet, the at least one piece of validated user information, that is sent to it by the wallet service provider electronic device, to at least one disallowed list contained on at least one screening service database, further wherein if the at least one piece of validated user information matches at least one identity on the at least one disallowed list, the wallet service provider electronic device deactivates the sender's wallet, and if the at least one piece of validated user information does not match at least one identity on the at least one disallowed list, the wallet service provider electronic device does not deactivate the sender's wallet.

5. The system and method of claim 3 further comprising:
a) the screening service electronic device compares, prior to activation of the sender's wallet, the at least one piece of validated user information, that is sent to it by the wallet service provider electronic device, to at least one disallowed list contained on at least one screening service database, further wherein if the at least one piece of validated user information matches at least one identity on the at least one disallowed list, the wallet service provider electronic device deactivates the sender's wallet, and if the at least one piece of validated user information does not match at least one identity on the at least one disallowed list, the wallet service provider electronic device does not deactivate the sender's wallet.

6. The system and method of claim 4 further comprising:
a) the wallet service provider electronic device verifying that the at least one human who has opened the sender's wallet is the at least one individual human that created the sender's wallet each time the sender's wallet is opened;
b) creating a sender's public address through the sender's wallet and creating a receiver's public address through a receiver's wallet and both addresses being sent to the wallet service provider electronic device by the respective wallets, wherein the receiver's wallet is included in a set of software instructions stored on a receiver's wallet electronic device which is one of the at least four electronic devices;
c) a sender of a transaction entering the details of the transaction through the sender's wallet; and
d) the wallet service provider electronic device sending information to a wallet validation service electronic device to establish that at least one security standard for the sender's wallet and the receiver's wallet has been met, wherein if the at least one security standard has been met, the wallet service provider electronic device allows the crypto asset transaction to occur, and further wherein if the at least one security standard has not been met, the wallet service provider electronic device cancels the crypto asset transaction.

7. The system and method of claim 5 further comprising:
a) the wallet service provider electronic device verifying that the at least one human who has opened the sender's wallet is the at least one individual human that created the sender's wallet each time the sender's wallet is opened;
b) creating a sender's public address through a sender's wallet and creating a receiver's public address through a receiver's wallet and the sender's public address and the receiver's public address being sent to the wallet service provider electronic device via the respective wallets, wherein the receiver's wallet is included in a set of software instructions stored on a receiver's wallet electronic device which is one of the at least four electronic devices;
c) a sender of a transaction entering the details of the transaction through the sender's wallet; and
d) the wallet service provider electronic device sending information to a wallet validation service electronic device to establish that at least one security standard for the sender's wallet and the receiver's wallet has been met, wherein if the at least one security standard has been met, the wallet service provider electronic device allows the crypto asset transaction to occur, and further wherein if the at least one security standard has not been met, the wallet service provider electronic device cancels the crypto asset transaction.

8. The system and method of claim 6 further comprising:
a) the sender's or receiver's wallet being linked to a financial institution electronic device by a link provided by the wallet service provider electronic device, wherein the financial institution electronic device is one of the at least four electronic devices;
b) generating a unique wallet reference key identification through the sender's or the receiver's wallet and communicating this information to the wallet service provider electronic device, wherein the unique wallet reference key identification and the at least one piece of validated user information are communicated to the financial institution electronic device by the wallet service provider electronic device;
c) the wallet service provider electronic device sending all the public addresses generated by the sender's or the receiver's wallet to the financial institution electronic device, wherein the public addresses are sent to the financial institution electronic device along with the unique wallet reference key identification; and
d) the financial institution electronic device organizing the activity of the sender's or the receiver's wallet by the unique wallet reference key identification and the public addresses.

9. The method of claim 7 further comprising:
a) the sender's or the receiver's wallet being linked to a financial institution electronic device by a link provided by the wallet service provider electronic device, wherein the financial institution electronic device is one of the at least four electronic devices;
b) generating a unique wallet reference key identification through the sender's or the receiver's wallet and sending the unique wallet reference key identification to the wallet service provider electronic device, wherein the unique wallet reference key identification and the at least one piece of validated user information are communicated to the financial institution electronic device by the wallet service provider electronic device;
c) the wallet service provider electronic device sending all the public addresses generated by the sender's or the receiver's wallet to the financial institution electronic device, wherein the public addresses are sent to the financial institution electronic device along with the unique wallet reference key identification; and
d) the financial institution electronic device organizing the activity of the sender's or the receiver's wallet by the unique wallet reference key identification and the public addresses.

10. The system and method of claim 1 further comprising:
a) the wallet service provider electronic device sending an internet protocol address of a sender's wallet electronic device on which the wallet is opened to the screening service electronic device, wherein if the internet protocol address is identified by the screening service electronic device, through at least one screening service database, as originating from at least one disallowed location, the wallet service provider electronic device deactivates the wallet until the internet protocol address on which the sender's wallet electronic device is opened is determined by the screening service electronic device to originate from a location that is not at least one disallowed location.

11. A method of using a crypto asset wallet with enhanced security features for verifying an identity of at least one user comprising:
a) creating a crypto asset wallet;
b) entering at least one piece of user information;
c) a wallet validation service or a wallet service provider validating an identity of the at least one user through the at least one piece of user information, wherein the at least one piece of user information that has been validated is at least one piece of validated user information;
d) a screening service screening the at least one user based on the at least one piece of validated user information; and
e) the wallet service provider risk rating the at least one user based on the at least one piece of validated user information.

12. The method of claim 11 further comprising:
a) creating either a personal or a commercial wallet, wherein the at least one user of the personal wallet is at least one identifiable individual and the at least one user of the commercial wallet is at least one entity and at least one signatory user;
b) providing, through the wallet to the wallet service provider, at least one photograph identification card as the at least one piece of validated user information;
c) the wallet photographing the at least one identifiable individual user or the at least one signatory user establishing the wallet before the wallet is activated through a camera on an electronic device and sending the photograph to the wallet service provider; and
d) the wallet service provider comparing the photograph taken by the camera on the electronic device with a photograph on the photograph identification card to verify the identity of the at least one identifiable individual user or the at least one signatory user, wherein if the identity of the at least one identifiable individual user or the at least one signatory user is verified, the wallet is not deactivated and if the identity of the at least one identifiable individual user or the at least one signatory user is not verified, the wallet is deactivated.

13. The method of claim 11 further comprising:
a) creating either a personal or a commercial wallet, wherein the at least one user of the personal wallet is at least one identifiable individual and the at least one user of the commercial wallet is at least one entity and at least one signatory user; and
b) the wallet service provider verifying the identity of the at least one identifiable individual user or the at least one signatory user before the wallet is activated by sending the at least one piece of validated user information to a third party verification service, wherein the third party verification service compares the at least one piece of validated user information to at least one piece of user information the third party verification service has on file or has access to regarding the at least one identifiable individual user or the at least one signatory user, further wherein if the third party verification service can verify the identity of the at least one identifiable individual user or the at least one signatory user through the comparison, the wallet is not deactivated and if the third party verification service cannot verify the identity of the at least one identifiable individual user or the at least one signatory user through the comparison, the wallet is deactivated.

14. The method of claim 12 further comprising:
a) using a screening service to screen the at least one identifiable individual user or the at least one signatory user, wherein the screening service compares the at least one piece of validated user information to at least one disallowed list, further wherein if the at least one piece of validated user information matches at least one identity on the at least one disallowed list, the wallet is deactivated, and if the at least one piece of validated user information does not match at least one identity on the at least one disallowed list, the wallet is not deactivated.

15. The method of claim 13 further comprising:
a) using a screening service to screen the at least one identifiable individual user or the at least one signatory user, wherein the screening service compares the at least one piece of validated user information to at least one disallowed list, further wherein if the at least one piece of validated user information matches at least one identity on the at least one disallowed list, the wallet is deactivated and if the at least one piece of validated user information does not match at least one identity on the at least one disallowed list, the wallet is not deactivated.

16. The method of claim 14 further comprising:
a) opening the wallet once it has been activated;
b) the wallet service provider verifying that the at least one user who has opened the wallet is the at least one identifiable individual user that created the wallet or is the at least one signatory user of the commercial wallet;
c) creating a sender's public address through a sender's wallet and creating a receiver's public address through a receiver's wallet;
d) entering the details of a transaction through the sender's wallet;
e) establishing at least one security standard for the sender's wallet and the receiver's wallet;
f) a wallet validation service verifying that both the sender's wallet and the receiver's wallet meet the at least one security standard; and
g) completing the crypto asset transaction.

17. The method of claim 15 further comprising:
a) opening the wallet once it has been activated;
b) the wallet service provider verifying that the at least one user who has opened the wallet is the at least one identifiable individual user that created the wallet or is the at least one signatory user of the commercial wallet;
c) creating a sender's public address through a sender's wallet and creating a receiver's public address through a receiver's wallet;
d) entering the details of a transaction through the sender's wallet;
e) establishing at least one security standard for the sender's wallet and the receiver's wallet;
f) a wallet validation service verifying that both the sender's wallet and the receiver's wallet meet the at least one security standard; and
g) completing the crypto asset transaction.

18. The method of claim 16 further comprising:
a) linking the sender's or the receiver's wallet to a financial institution through a financial institution interface;
b) generating a unique wallet reference key identification through the sender's or the receiver's wallet, wherein the unique wallet reference key identification and the at least one piece of validated user information are communicated to the wallet service provider and then, through the wallet service provider, to the financial institution;
c) sending all the public addresses generated by the sender's or the receiver's wallet to the wallet service provider and then, through the wallet service provider, to the financial institution, wherein the public addresses are sent to the financial institution along with the unique wallet reference key identification; and
d) organizing the activity of the sender's or the receiver's wallet by the financial institution through the unique wallet reference key identification and the public addresses.

19. The method of claim 17 further comprising:
a) linking the sender's or the receiver's wallet to a financial institution through a financial institution interface;
b) generating a unique wallet reference key identification through the sender's or the receiver's wallet, wherein the unique wallet reference key identification and the at least one piece of validated user information are communicated to the wallet service provider and then, through the wallet service provider, to the financial institution;
c) sending all the public addresses generated by the sender's or the receiver's wallet to the wallet service provider and then, through the wallet service provider, to the financial institution, wherein the public addresses are sent to the financial institution along with the unique wallet reference key identification; and
d) organizing the activity of the sender's or the receiver's wallet by the financial institution through the unique wallet reference key identification and the public addresses.

20. A crypto asset wallet comprising:
a) a wallet, wherein at least one user is able to access the wallet through at least one login credential;
b) the wallet having a send and a receive function, wherein the wallet is able to send and receive at least one crypto asset; and
c) the wallet having a deactivation function, wherein the wallet can be deactivated by a wallet service provider based on input from the wallet or from at least one third party service, further wherein once the wallet is deactivated, it cannot be used to send or receive the at least one crypto asset.

21. The crypto asset wallet of claim 20 further comprising:
a) the wallet, through the wallet service provider, having at least one user identification function, wherein the identification of at least one user is verified before the wallet is activated;
b) the wallet, through the wallet service provider, having at least one user screening feature, wherein the identity of the at least one user is screened against at least one disallowed list, and further wherein if the identity of the at least one user matches at least one identity of the at least one disallowed list, the wallet is deactivated;
c) the wallet, through the wallet service provider, having at least one internet protocol address screening feature, wherein at least one internet protocol address on an electronic device used to open the wallet is screened, wherein if the at least one internet protocol address is associated with at least one disallowed location, the wallet is deactivated; and
d) the wallet, through the wallet service provider, having at least one wallet validation feature, wherein at least one sender's wallet and at least one receiver's wallet are validated for at least one wallet requirement, wherein if either the at least one sender's wallet or the at least one receiver's wallet do not meet the at least one wallet requirement, a crypto asset transaction fails.

22. The crypto asset wallet of claim 21 further comprising:
a) the sender's or the receiver's wallet having at least one financial institution linking function, wherein the sender's or the receiver's wallet is able to link to a user account at a financial institution, through a wallet service provider, further wherein the sender's or the receiver's wallet is only able link to one financial institution at a time and if it is desired to link to a second financial institution with the same wallet, the link to the first financial institution must be deactivated; and
b) the sender's or the receiver's wallet being able to create a wallet reference key identification, wherein the sender's or the receiver's wallet sends the wallet reference key identification and at least one piece of wallet information to the wallet service provider then, through the wallet service provider, to the financial institution without any identifiable user information.

23. The crypto asset wallet of claim 22 further comprising:
a) the sender's or the receiver's wallet, through the wallet service provider, accepting at least one photograph identification card as one of at least one piece of user information, wherein the wallet service provider validates the identity of the at least one user establishing the wallet through at least one photograph of the at least one user taken with a camera of the electronic device and comparing the at least one photograph from the camera of the electronic device with a photograph on the at least one photograph identification card, further wherein if the two photographs do not match, the wallet is deactivated.
